(19) United States
(12) Patent Application Publication
(10) Pub. No.: US 2018/0126428 A1
(43) Pub. Date: May 10, 2018

(54) Pipe Cleaning Apparatus

(71) Applicant: SDY International Co., Ltd., Taichung City (TW)

(72) Inventor: Wei-Tien Hsu, Taichung City (TW)

(21) Appl. No.: 15/344,625

(22) Filed: Nov. 7, 2016

(51) Int. Cl. B08B 9/045

(52) U.S. Cl. CPC B08B 9/045

(57) ABSTRACT

A pipe cleaning apparatus includes a storage drum, a hollow cylinder, a spring tube, an elastic brake, a grip, and at least one pad. The cylinder is provided with an outer slot and a clearance hole. The spring tube is held inside the storage drum and the cylinder. The elastic brake includes a fixed portion held in the outer slot and an actuating portion extending through the clearance hole and being movable between inside and outside of the cylinder. The grip can be axially moved relative to the cylinder for controlling movement of the actuating portion. The at least one pad is installed in the cylinder for positioning the spring tube. As such, a user moving the grip can control positions of the actuating portion to fix or release the spring tube.

### BACKGROUND OF THE INVENTION

The present invention relates to a pipe cleaning apparatus and, more particularly, to a device for unclogging a jammed pipe.

FIGS. 1 and 2 illustrates a conventional pipe cleaning apparatus 100a including a shell body 10a, a connecting cylinder 20a, a grip 30a, a retaining latch 40a, and a spring tube 200a. A rear side of the shell body 10a is provided with a handle 11a. The connecting cylinder 20a is connected to a front side of the shell body 10a. The grip 30a is mounted under the connecting cylinder 20a, and the retaining latch 40a is installed on a front side of the connecting cylinder 20a. The spring tube 200a has a rear segment coiled inside the shell body 10a and a front segment penetrating the connecting cylinder 20a and exposed to outside of the cylinder 20a. A user of the conventional pipe cleaning apparatus 100a should extract one segment of the spring tube 200a from the front side of the connecting cylinder 20a and lock the retaining latch 40a to fix the spring tube 200a. With a jammed pipe dredged, a user who wants to retract the spring tube 200a should loosen the retaining latch 40a to release the spring tube 200a and rotate the handle 11a to haul the extended segment of the spring tube 200a back. It is an inconvenient process that a user who is extending or retracting the spring tube 200a usually struggles to rotate the retaining latch 40a manually. Moreover, the spring tube 200a which is probably damaged with the retaining latch 40a tightened excessively falls short of normal service life.

### BRIEF SUMMARY OF THE INVENTION

It is an objective of the present invention to provide a pipe cleaning apparatus which is a simple device in structure and features a spring tube which is fixed or released with a movable grip, convenient usage, and long service life.

To achieve this and other objectives, a pipe cleaning apparatus of the present invention includes a storage drum, a hollow cylinder, a spring tube, an elastic brake, a grip, and at least one pad. The cylinder is connected to a front side of the storage drum and has an interior in communication with the storage drum. The cylinder includes an outer slot therein and a clearance hole linking the outer slot. The spring tube includes a rear segment received in the storage drum and a front segment penetrating the cylinder and exposed to a front end of the cylinder. The spring tube can be moved when the storage drum is rotated relative to the cylinder. The elastic brake includes a fixed portion and an actuating portion formed at an end of the fixed portion. The fixed portion is held in the outer slot, and the actuating portion extends through the clearance hole and is movable between inside and outside of the cylinder. The grip includes a handgrip portion and a cartridge portion linking a top of the handgrip portion. The cartridge portion is mounted around and can be axially shifted relative to the cylinder for controlling movement of the actuating portion between inside and outside of the cylinder. The at least one pad is installed inside the cylinder and opposite to the outer slot of the cylinder. An outer end of the at least one pad includes a raised edge and a crest on the raised edge. The actuating portion moved to inside of the cylinder pushes against the spring tube so that the spring tube is positioned with the crest on the pad embedded into the spring tube. The actuating portion moved to outside of the cylinder releases pressure applied on the spring tube so that the spring tube is movable freely.

Preferably, the cylinder is provided with a shoulder adjacent to the front end of the cylinder. Both ends of the cartridge portion are respectively limited by the storage drum and the shoulder when the grip is moved back and forth relative to the cylinder.

In an embodiment, the at least one pad includes two separate curved pads, and each of the two curved pads has an L-shaped profile and includes the raised edge at an outer end thereof.

In another embodiment, the at least one pad includes a curved pad having two raised edges at both outer ends thereof, with each of the two raised edges provided with an arrowed crest.

The present invention will become clearer in light of the following detailed description of illustrative embodiments of this invention described in connection with the drawings.

### DESCRIPTION OF THE DRAWINGS

FIG. 1 is a schematic view of a conventional pipe cleaning apparatus with a spring tube fixed.

FIG. 2 is a schematic view of the conventional pipe cleaning apparatus in FIG. 1 with the spring tube released.

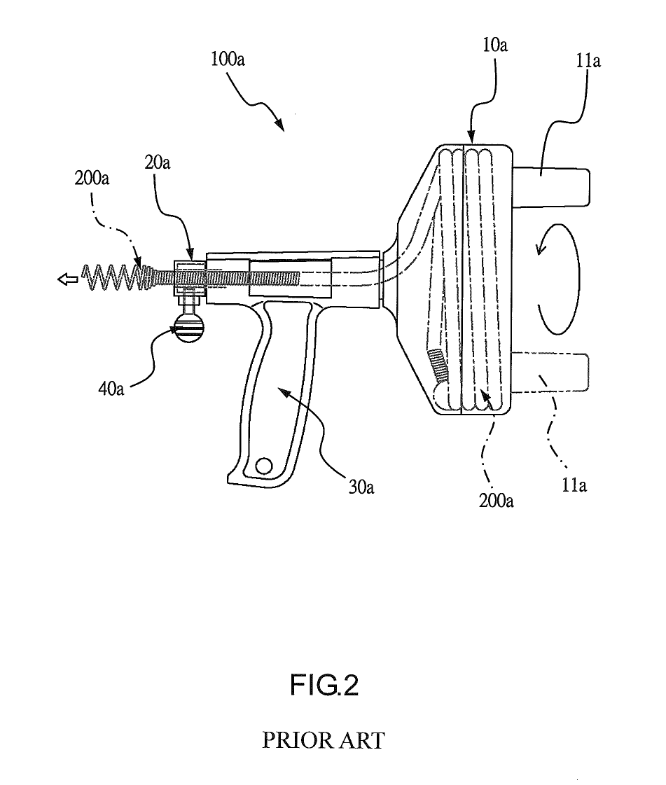

FIG. 3 is a perspective view of a pipe cleaning apparatus according to an embodiment of the present invention.

FIG. 4 is an exploded view of the pipe cleaning apparatus of FIG. 3.

FIG. 5 is a sectional, schematic view of the pipe cleaning apparatus of FIG. 3.

FIG. 6 is a schematic view which illustrates a spring tube in the pipe cleaning apparatus of FIG. 5 is fixed.

FIG. 7 is a schematic view which illustrates the spring tube in FIG. 6 is released.

FIG. 8 is a sectional, schematic view of a storage drum in the pipe cleaning apparatus of FIG. 3.

FIG. 9 is a perspective view which illustrates a pad of the pipe cleaning apparatus of FIG. 4 in another embodiment.

### DETAILED DESCRIPTION OF THE INVENTION

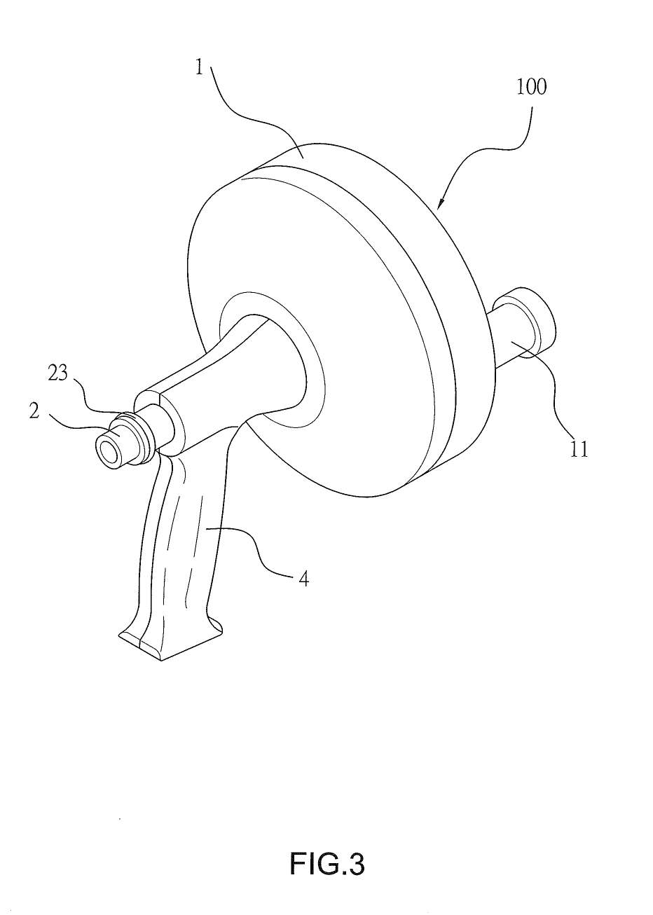

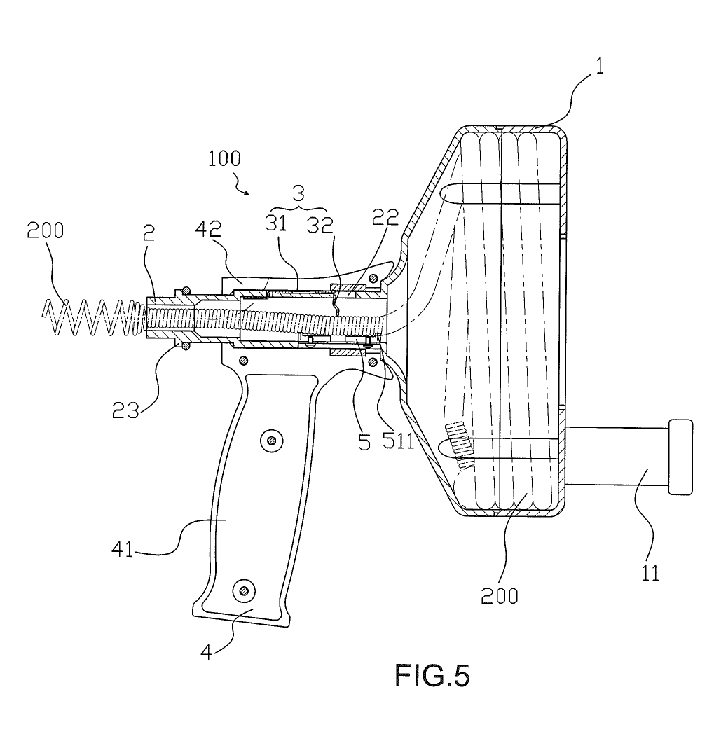

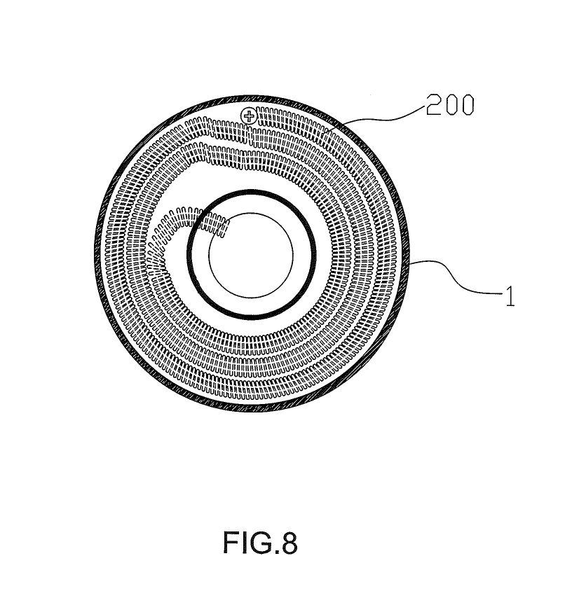

A pipe cleaning apparatus according to an embodiment of the present invention is shown in FIGS. 3 through 8 of the drawings and generally designated 100. The pipe cleaning apparatus 100 includes a storage drum 1, a hollow cylinder 2, a spring tube 200, an elastic brake 3, a grip 4, and at least one pad 5. A handle 11 is provided on a rear side of the storage drum 1 and is used to rotate the storage drum 1. The cylinder 2 is connected to a front side of the storage drum 1, and an interior of the cylinder 2 is in communication with the storage drum 1. The cylinder 2 is provided with an outer slot 21 therein and a clearance hole 22 therein, both of which are link each other. In this embodiment, the outer slot 21 is farther away from the storage drum 1 than the clearance hole 22; alternatively, the outer slot 21 is closer to the storage drum 1 than the clearance hole 22.

The spring tube 200 includes an inner end fixed in the storage drum 1 and a rear segment coiled in the storage drum 1. The spring tube 200 further includes a front segment penetrating the cylinder 2 and exposed to a front end of the cylinder 2. When the handle 11 is rotated to rotate the storage drum 1 relative to the cylinder 2, the spring tube 200 is driven to move.

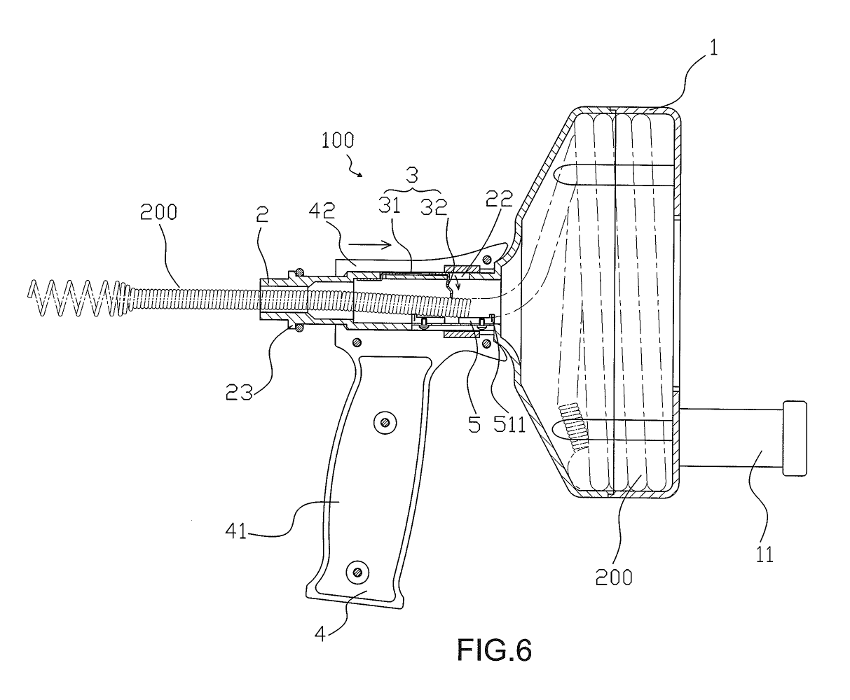

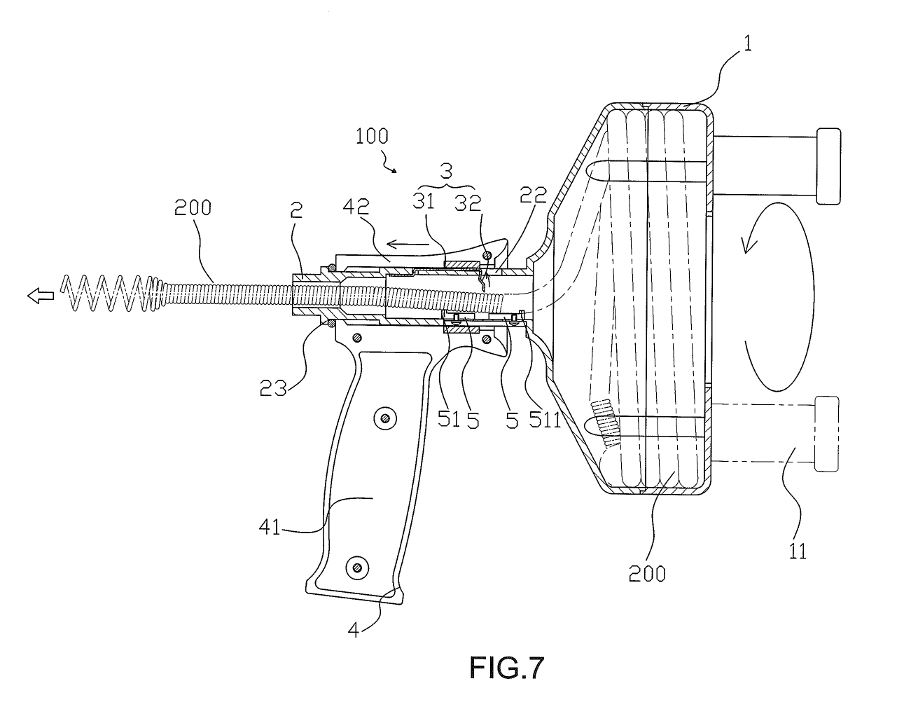

The elastic brake 3 includes a fixed portion 31 and an actuating portion 32 formed at a rear end of the fixed portion 31. The fixed portion 31 is held in the outer slot 21, and the actuating portion 32 is movable between inside and outside of the cylinder 2 through the clearance hole 22. The actuating portion 32 moved to inside of the cylinder 2 pushes against the spring tube 200 for fixed status (FIG. 6); the actuating portion 32 moved to outside of the cylinder 2 releases pressure applied on the spring tube 200 for loosened status (FIG. 7). In this embodiment, the elastic brake 3 is constructed as but not limited to an elastic sheet.

The grip 4 consists of two split grip portions 40 opposite to each other, and each of the grip portions 40 includes a handgrip portion 41 and a cartridge portion 42 which links the top of the handgrip portion 41. The cartridge portion 42 is mounted around and can be axially shifted relative to the cylinder 2. The grip 4 moved back and forth is to control the actuating portion 32 to be moved between inside and outside of the cylinder 2. In this embodiment, the cylinder 2 is provided with a shoulder 23 adjacent to the front end of the cylinder 2 and far away from the front side of the storage drum 1. Both ends of the cartridge portion 42 are respectively limited by the storage drum 1 and the shoulder 23 when the grip 4 is axially moved back and forth relative to the cylinder 2.

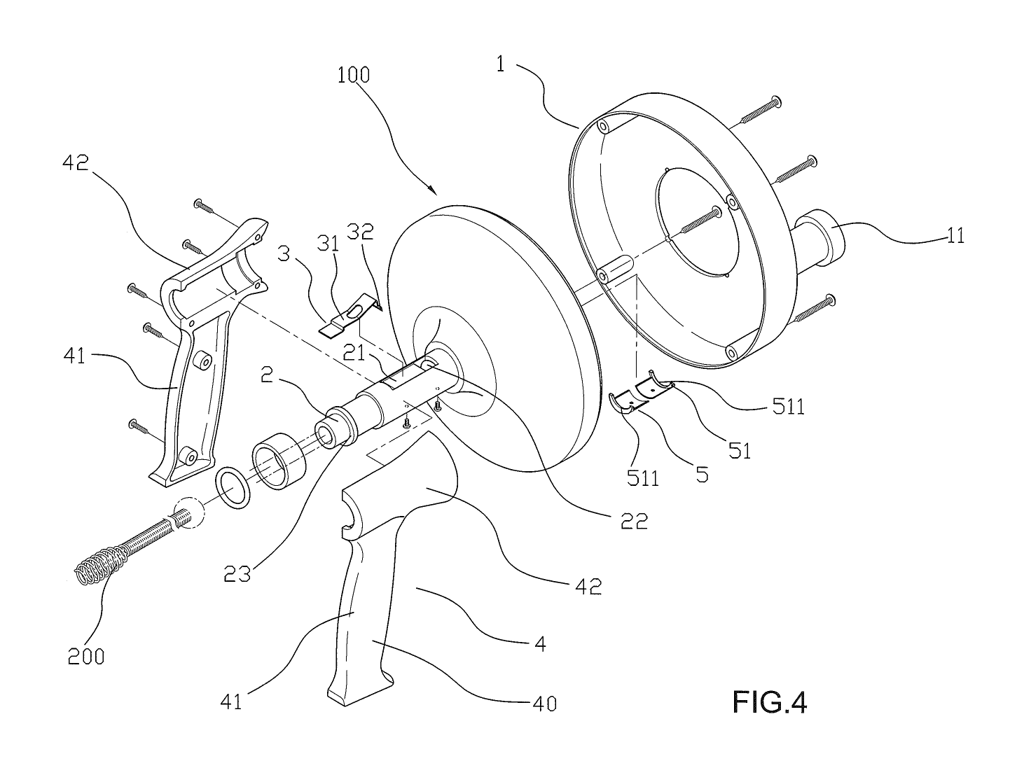

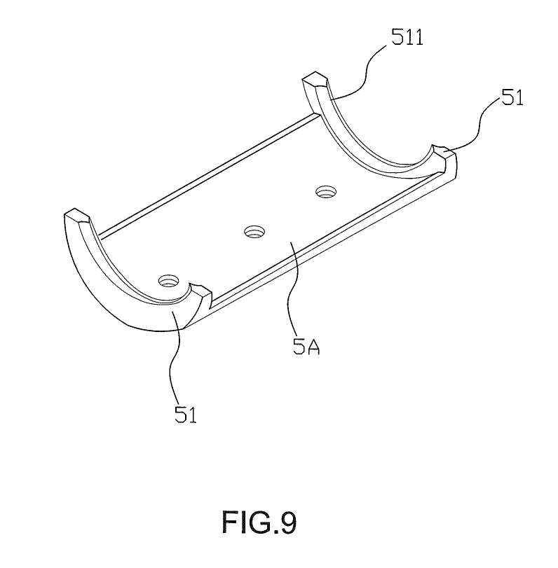

The at least one pad 5 is installed inside the cylinder 2 and opposite to the outer slot 21 of the cylinder 2. In this embodiment, the cylinder 2 is internally provided with two separate curved pads 5, each of which includes a raised edge 51 at an outer edge and has an L-shaped profile. An arrowed crest 511 is formed on each raised edge 51 and can be closely embedded into a spring pitch of the spring tube 200 for correct positioning when the actuating portion 32 of the elastic brake 3 pushes against the spring tube 200. FIG. 9 illustrates a pad 5A of the pipe cleaning apparatus 100 in another embodiment. Each of two outer ends of the pad 5A is provided with a raised edge 51 and a crest 511, so that the pad 5A can be used to replace the two pads 5 in FIG. 4. However, the pads 5 in FIG. 4 can be manufactured and installed easily.

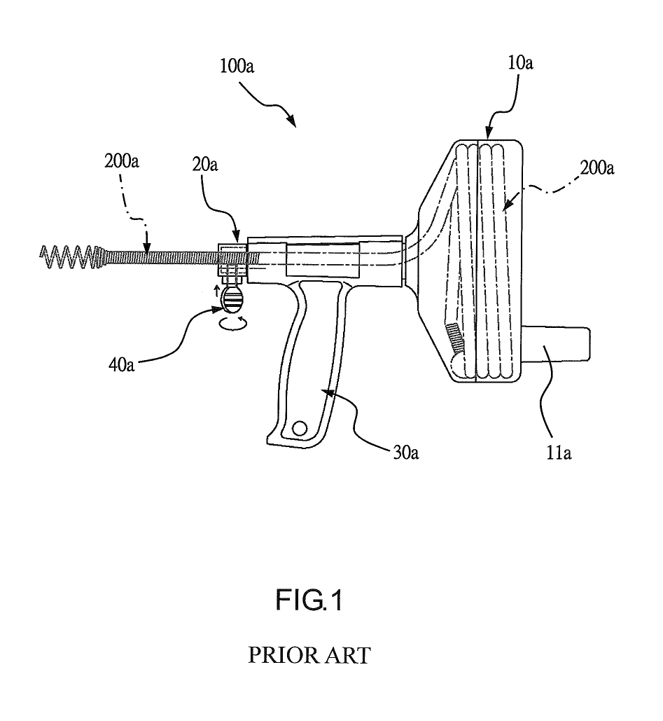

When the grip 4 is moved forward away from the storage drum 1 (FIG. 7) in usage of the pipe cleaning apparatus 100, pressure applied on the spring tube 200 by the actuating portion 32 is released, and the spring tube 200 can be freely moved and driven with the handle 11 rotated. On the other hand, when the grip 4 is moved backward toward the storage drum 1 (FIG. 6), the actuating portion 32 pushes against the spring tube 200, so that the spring tube 200 is fixed and unmoved during operation of the pipe cleaning apparatus 100 with the crests 511 of the pads 5 embedded into the spring tube 200. Therefore, the pipe cleaning apparatus 100 is more convenient for operation than the conventional pipe cleaning apparatus 100a in FIG. 1.

Thus since the invention disclosed herein may be embodied in other specific forms without departing from the spirit or general characteristics thereof, some of which forms have been indicated, this embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A pipe cleaning apparatus comprising:
a storage drum;
a cylinder connected to a front side of the storage drum and including an interior in communication with the storage drum, with the cylinder further including an outer slot therein and a clearance hole linking the outer slot;
a spring tube including a rear segment received in the storage drum and a front segment penetrating the cylinder and exposed to a front end of the cylinder, with the spring tube moved when the storage drum is rotated relative to the cylinder;
an elastic brake including a fixed portion and an actuating portion formed at an end of the fixed portion, with the fixed portion held in the outer slot, with the actuating portion extending through the clearance hole and being movable between inside and outside of the cylinder;
a grip including a handgrip portion and a cartridge portion linking a top of the handgrip portion and mounted around the cylinder, wherein the cartridge portion can be axially shifted relative to the cylinder for controlling movement of the actuating portion between inside and outside of the cylinder; and
at least one pad installed inside the cylinder and opposite to the outer slot of the cylinder, with an outer end of the at least one pad including a raised edge and a crest on the raised edge;
wherein the actuating portion moved to inside of the cylinder pushes against the spring tube so that the spring tube is positioned with the crest on the at least one pad embedded into the spring tube, and
wherein the actuating portion moved to outside of the cylinder releases pressure applied on the spring tube so that the spring tube is movable freely.

2. The pipe cleaning apparatus according to claim 1, wherein the cylinder is provided with a shoulder adjacent to the front end of the cylinder, wherein both ends of the cartridge portion are respectively limited by the storage drum and the shoulder when the grip is axially moved back and forth relative to the cylinder.

3. The pipe cleaning apparatus according to claim 1, wherein the at least one pad includes two separate curved pads, with each of the two curved pads having an L-shaped profile and including the raised edge at an outer end thereof.

4. The pipe cleaning apparatus according to claim 1, wherein the at least one pad includes a curved pad having two raised edges at both outer ends thereof, with each of the two raised edges provided with an arrowed crest.

5. The pipe cleaning apparatus according to claim 1, wherein the outer slot is farther away from or closer to the storage drum than the clearance hole.

6. The pipe cleaning apparatus according to claim 1, wherein the elastic brake is an elastic sheet.

7. The pipe cleaning apparatus according to claim 1, wherein the grip consists of two split grip portions opposite to each other.

8. The pipe cleaning apparatus according to claim 1, wherein a handle is provided on a rear side of the storage drum for rotating the storage drum.
